(19) United States
(12) Patent Application Publication
(10) Pub. No.: US 2012/0163171 A1
(43) Pub. Date: Jun. 28, 2012

(54) ROUTING METHOD AND APPARATUS FOR SUPPORTING QoS IN WIRELESS NETWORK

(75) Inventors: Anseok LEE, Daejeon (KR); Hyun-Jae Kim, Incheon (KR); Kwang Jae Lim, Daejeon (KR); Dong Seung Kwon, Daejeon (KR)

(73) Assignee: ELECTRONICS AND TELECOMMUNICATIONS RESEARCH INSTITUTE, Daejeon (KR)

(21) Appl. No.: 13/296,497

(22) Filed: Nov. 15, 2011

(30) Foreign Application Priority Data
Dec. 23, 2010 (KR) 10-2010-0133698

(51) Int. Cl. H04W 40/00; H04W 72/04

(52) U.S. Cl. 370/231; 370/230

(57) ABSTRACT

A method for routing and setting up a connection to provide Quality of Service (QoS) required in a wireless network is provided, which allows to use a path capable of providing QoS higher than a certain level between a source node and a destination node. A routing apparatus includes: a connection management unit that receives a connection setup request directed to a destination node, determines a predicted path leading to the destination node and the next node, and transmits a connection setup request to the next node; a resource allocation unit that allocates resources so as to satisfy required QoS; a routing unit that measures available QoS information of a link and enables the exchange of information of the link including the QoS information with the nodes of the network; and a routing information management unit that stores received routing information.

### CROSS-REFERENCE TO RELATED APPLICATION

This application claims priority to and the benefit of Korean Patent Application No. 10-2010-0133698 filed in the Korean Intellectual Property Office on Dec. 23, 2010, the entire contents of which are incorporated herein by reference.

### BACKGROUND OF THE INVENTION

(a) Field of the Invention

The present invention relates to a wireless network. More particularly, the present invention relates to a routing method and apparatus for supporting QoS (Quality of Service) in a wireless network.

(b) Description of the Related Art

Wireless networks are being studied as a communication means for various purposes. Particularly, a multi-hop wireless network is gaining more and more attention, which can cut down construction costs because the infrastructure is small and cheap compared to a cellular network, and which can be constructed fast even in an environment, such as a battlefield, where it is difficult to install the infrastructure.

Meanwhile, the channel condition of a wireless network changes over time, and this leads to the problem that the transmission rate of a link that connects nodes also changes over time. Also, the simultaneous use of multiple adjacent links increases the probability of a transmission failure due to interference.

In a cellular network which only uses a single hop communication, a base station that controls all transmissions within a cell, exists and the base station supports QoS. On the other hand, in a multi-hop wireless network, no central unit for managing QoS exists, so it is relatively difficult to support QoS.

A TCP (Transmission Control Protocol) is a protocol of a transmission layer that operates over an IP (Internet Protocol) layer. The TCP performs the flow control and congestion control of multi-hop communication, thus providing stable and proper end-to-end transmission. Although the TCP sets up a connection, the TCP only sets up a connection between a source node and a destination but is not involved in setting up a connection of an intermediate node. Thus, the TCP cannot guarantee QoS for each link.

Like the TCP, an RSVP (Resource Reservation Protocol) is a protocol that operates over an IP layer. The RSVP is usually used to reserve resources for stably transmitting multimedia data, and passes a resource reservation request message to reserve resources at a link layer of each intermediate node. However, link layers of many wireless networks currently operating do not support such a resource reservation method, thus making it difficult to apply the RSVP to a wireless network.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a routing method and apparatus for supporting QoS in a wireless network.

A method for a first node to set up a connection in a wireless network according to an exemplary embodiment of the present invention includes: receiving a connection setup request directed to a destination node; determining a predicted path leading to the destination node and a second node that follows; allocating resources between the first node and the second node so as to satisfy required link QoS (Quality of Service); transmitting a connection setup request to the second node through the allocated resources; and receiving a connection setup complete message from the destination node.

A method for a first node to restore a connection to support QoS in a wireless network according to an exemplary embodiment of the present invention includes: receiving a QoS failure message indicative of a failure in QoS provision from a second node present on a routing path; determining a third node to initiate the restoration of a connection; transmitting a restoration request message to the third node; and receiving a connection setup complete message from a destination node.

A method for a first node to set up a routing path to support QoS in a wireless network according to an exemplary embodiment of the present invention includes: exchanging routing information with a second node being a neighboring hood; forming a network topology based on the routing information received from the second node; receiving a connection setup request directed to the destination node; and determining a predicted path leading to the destination node and a third node that follows based on the network topology.

A method for a first node to allocate resources to support QoS in a wireless network according to an exemplary embodiment of the present invention includes: deriving link QoS from required end-to-end QoS; and allocating resources to a second node that follows on a predicted path so as to satisfy the link QoS.

An apparatus for routing at a first node to support QoS in a wireless network according to an exemplary embodiment of the present invention includes: a connection management unit that receives a connection setup request directed to a destination node, determines a predicted path leading to the destination node and a second node that follows, and transmits a connection setup request to the second node; and a resource allocation unit that allocates resources so as to satisfy link QoS required between the first node and the second node.

### BRIEF DESCRIPTION OF THE DRAWINGS

FIG. 1 is a view showing a wireless Ad hoc network according to an exemplary embodiment of the present invention.

FIG. 2 is a view showing a TDMA frame structure.

FIG. 3 is a block diagram showing a routing apparatus according to an exemplary embodiment of the present invention.

FIG. 4 is an example of a network topology formed by a routing information management unit.

FIG. 5 is a flowchart showing a method for a connection management unit of the routing apparatus to set up a connection according to an exemplary embodiment of the present invention.

FIG. 6 is a flowchart showing the operation of the connection management unit upon receiving a connection request from an upper layer or other nodes according to an exemplary embodiment of the present invention.

FIG. 7 is a flowchart showing a method for the connection management unit of the routing apparatus to restore the connection that has failed in QoS provision according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements.

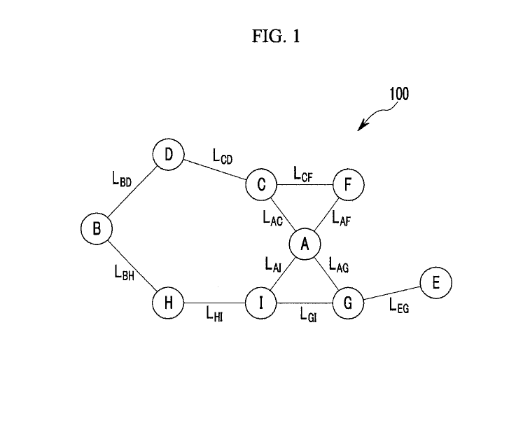

FIG. 1 is a view showing a wireless Ad hoc network according to an exemplary embodiment of the present invention.

Referring to FIG. 1, a wireless Ad hoc network 100 comprises a plurality of nodes (A, B, . . . , I). Each node can communicate with a neighboring node. A neighboring node refers to a node located adjacent to each node. For example, neighboring nodes of node A may include node C, node F, node I, and node G. A logical link is formed between each node and a neighboring node. For example, a link L_{AG} may be formed between node A and node C, and a link L_{AF} may be formed between node A and node F. A real line connected between two nodes in FIG. 1 represents a link formed between the two nodes.

An exemplary embodiment of the present invention is applicable to a wireless network using a typical link layer protocol, as well as a wireless Ad hoc network. According to TDMA (Time Division Multiple Access), the entire time is divided in time slots and the time slots are assigned to each node in a link layer protocol, and data transmission occurs at each time slot. Negotiation between nodes connected to each link is required for data transmission at each time slot.

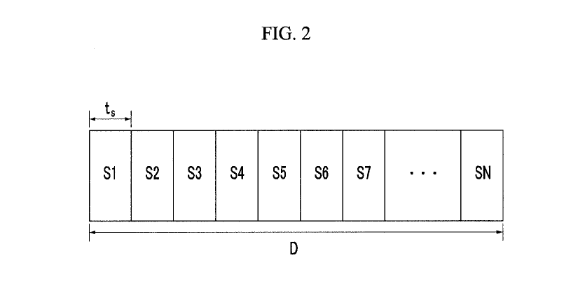

FIG. 2 is a view showing a TDMA frame structure.

Referring to FIG. 2, a TDMA frame structure comprises a plurality of time slots. The length of each time slot is ts. A fixed number of slots may be allocated in each TDMA frame of a predetermined length D for data transmission of each node.

Hereinafter, a routing apparatus and method for supporting QoS in a wireless Ad hoc network using a TDMA frame structure will be described with reference to the drawings.

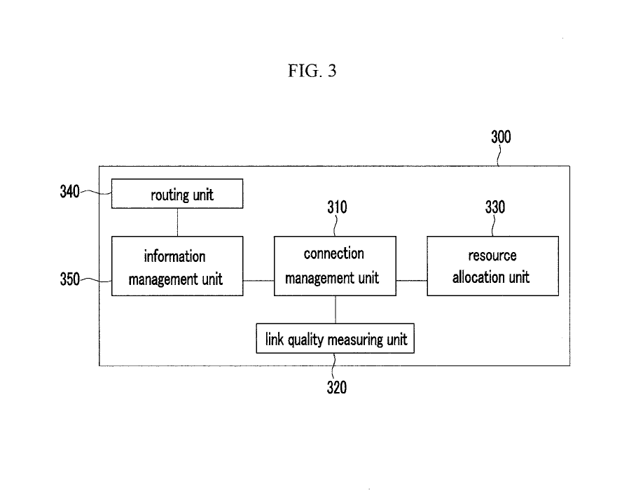

FIG. 3 is a block diagram showing a routing apparatus according to an exemplary embodiment of the present invention.

Referring to FIG. 3, a routing apparatus 300 comprises a connection management unit 310, a link quality measuring unit 320, a resource allocation unit 330, a routing unit 340, and a routing information management unit 350.

The connection management unit 310 sets up and manages a connection from a source node to a destination node upon receipt of an end-to-end transmission request from an upper layer. A detailed operation of the connection management unit 310 will be described later.

The link quality measuring unit 320 measures QoS of a link managed by a certain node. A link managed by a certain node refers to a link, in which the node is a sending node and one of neighboring nodes is a receiving node. QoS factors defined for each link include, for example, bandwidth and delay time. The link quality measuring unit 320 can measure bandwidth by measuring how much data can be transmitted over a certain link for a given period of time. Moreover, the link quality measuring unit 320 can measure delay time by measuring and averaging the delay from the time when data is generated or received to the time when the data is successfully delivered over the link for a given period of time.

The resource allocation unit 330 allocates resources of a link layer. The resource allocation unit 330 can allocate resources of a link layer that operates, for example, in a TDMS structure. As illustrated in FIG. 2, a typical TDMA frame has a fixed number of time slots, and the TDMA frame structure is repeated in frames. To perform communication over a single link, the sending node and the receive node negotiate whether to send or receive in a particular time slot within a frame. Such a process is called scheduling. The resource allocation unit 330 can allocate a transmission location and a transmission number by a scheduling process with an opposing node. The resource allocation unit 300 can perform scheduling with the opposing node by a method comprising a resource allocation request and a resource allocation response or a method comprising a resource allocation response and a resource allocation acknowledgment.

The resource allocation unit 330 can perform the operation of releasing allocated resources. For example, when the connection management unit 310 requests the release of resources, the resource allocation unit 330 can perform a resource release procedure with the opposing node by a method comprising a resource release request and a resource release response or a method comprising a resource release response and a resource release acknowledgment.

Moreover, the resource allocation unit 330 can allocate resources so as to satisfy link QoS. That is, the resource allocation unit 330 can determine the number and position of time slots allocated, based on the bandwidth and delay time of link QoS. Information about the bandwidth and delay time of link QoS can be received from the connection management unit 310. The link QoS refers to QoS required on a link managed by a certain node. Details of the derivation of link QoS will be described. Assuming that the total number of time slots in a typical TDMA frame is N, the length of each time slot is ts, and the amount of data that can be sent in onetime slot is X bits, the number of time slots allocated to satisfy link QoS is as shown in Equation 1, and the position of the time slots is as shown in Equation 2:

$$n \geq ⌈ \frac{{BW}_{s}}{X / {t}_{s}} ⌉ \qquad ( Equation 1 )$$

where n is the number of time slots allocated, and BWs[bits/sec] is the bandwidth of link QoS.

$${max}_{0 \leq i < n} \{ \vert K ( i + 1 ) - K ( i ) \vert \} \cdot {t}_{s} \leq {D}_{i} \qquad ( Equation 2 )$$

where K is a set of numbers of time slots allocated, K(i) is the allocation position of the i-th time slot, and DI is the delay time of link QoS. From this, it is found that the distance between two adjacent time slots should be less than DI.

The routing unit 340 exchanges routing information, i.e., information for selecting a path, with the opposing node. The routing unit 340 can exchange routing information by a typical LSR (Link State Routing) technique or OLSR (Optimized Link State Routing) technique. At this point, for the sake of QoS support, the routing unit 340 may deliver QoS information that can be provided by a given link to the nodes of the network. The QoS information that can be provided by a given link includes, for example, bandwidth and delay time. The bandwidth of a given link refers to the time slots that can be allocated between neighboring nodes. The delay time of a given link refers to the distance between adjacent slots farthest away from each other, among the time slots that can be allocated, i.e., the longest delay time when resources are optimally allocated. This means that the service can be provided if a required delay time is longer than or equal to the delay time of the link. The delay time of the link can be represented by Equation 4:

$${BW}_{a} = X \cdot \frac{n}{{t}_{s}} [ bps ] \qquad ( Equation 3 )$$

where BWa is a bandwidth that can be provided by the link, n is the number of time slots that can be allocated, and ts is the length of each time slot.

$${D}_{a} = {max}_{0 \leq i < n} \{ \vert K ( i + 1 ) - K ( i ) \vert \} \cdot {t}_{s} \qquad ( Equation 4 )$$

where Da is a delay time that can be provided by the link, K is a set of numbers of time slots that can be allocated, K(i) is the position of the i-th time slot among the slots that can be allocated, and ts is the length of each time slot.

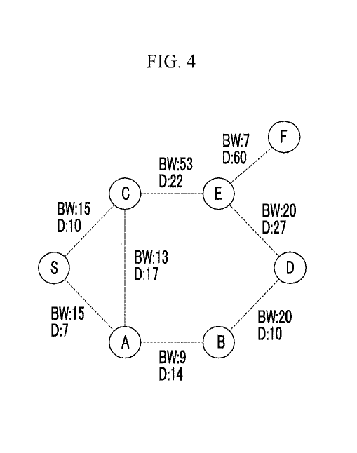

The routing information management unit 350 stores routing information received through the routing unit 340, and forms a network topology based on the routing information. FIG. 4 is an example of a network topology formed by the routing information management unit 350. Referring to FIG. 4, various paths, such as S-C-E-D and S-A-B-D, can be predicted for data transmission from a source node S to a destination node D. Assuming that the minimum bandwidth of end-to-end QoS required for data transmission from the source node S to the destination node D is 5 and the maximum delay time is 50, the source node S can select S-A-B-D having the smallest number of hops among the paths satisfying this condition, and transmit a resource allocation request and a connection setup request to node A.

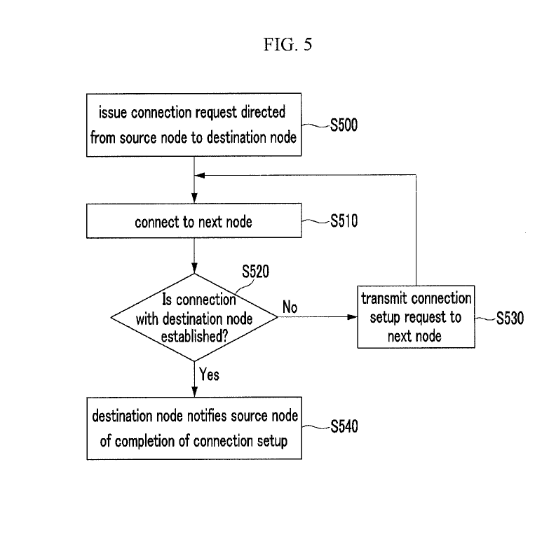

FIG. 5 is a flowchart showing a method for the connection management unit 310 of the routing apparatus 300 to set up a connection according to an exemplary embodiment of the present invention.

Referring to FIG. 5, when a data transmission request is issued from the source node to the destination node, the connection management unit 310 of the source node S receives a connection setup request from an upper layer (S500).

Hereupon, the connection management unit 310 sets up a connection to the next node, e.g., an intermediate node A (S510), and checks whether the connected node is the destination node D (S520). If the connected node is not the destination node D, the connection management unit 310 transmits a connection setup request to the next node, e.g., an intermediate node B (S530), and repeats the above process until a connection to the destination node D is established. When a connection with the destination node is established, the connection management unit 310 of the destination node D is able to notify the source node S of completion of the connection setup (S540).

In this way, the connection management unit 310 may have the function of receiving a data transmission request from an upper layer, the function of transmitting a connection request to other nodes, and the function of notifying the source node of completion of a connection setup upon receiving a connection request from other nodes or when the connection management unit 310 is included in the destination node. A detailed operation of the connection management unit 310 will be discussed below.

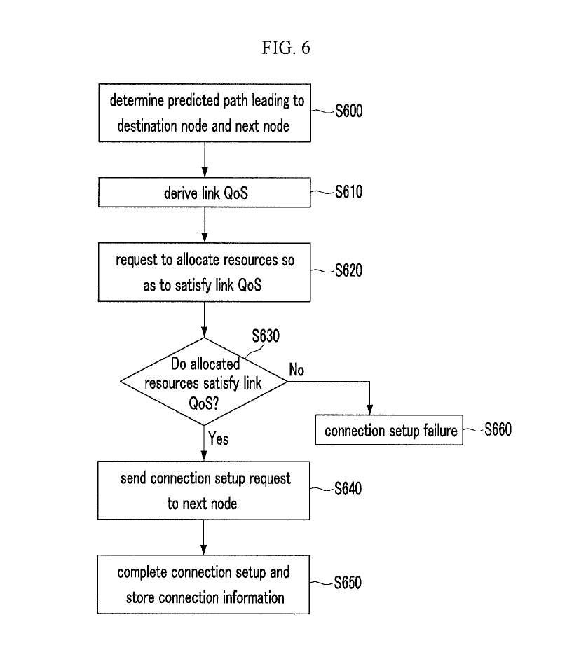

FIG. 6 is a flowchart showing the operation of the connection management unit 310 upon receiving a connection request from an upper layer or other nodes according to an exemplary embodiment of the present invention.

Referring to FIG. 6, the connection management unit 310 determines a predicted path leading to the destination node and the next node (S600). Here, the next node refers to a node adjacent to the current node, which is present on the predicted path. At this point, the connection management unit 310 can determine a predicted path satisfying a required QoS level and the next node by using the routing information stored in the routing information management unit 350. Here, the routing information includes network topology information and information of available bandwidth and delay time, i.e., QoS information of each link. The connection management unit 310 can select, as a predicted path, a path having the smallest number of hops among the paths satisfying the required end-to-end QoS level.

Next, the connection management unit 310 derives link QoS (S610). The link QoS is QoS required for a link between the current node and the next node, which can be derived based on the required end-to-end QoS level and the number of hops on the predicted path. For example, the bandwidth of link QoS is equal to the bandwidth of end-to-end QoS, and the delay time of link QoS is equal to a value obtained by dividing the delay time of end-to-end QoS by the number of hops on the predicted path.

Next, the connection management unit 310 requests the resource allocation unit 330 to allocate resources so as to satisfy the link QoS (S620). That is, the connection management unit 310 can pass the bandwidth of link QoS and the delay time of link QoS to the resource allocation unit 330.

If allocated resources satisfy the link QoS (S630), the connection management unit 310 sends a connection setup request to the connection management unit 310 of the next node (S640). The connection setup request includes a value representative of the link QoS of the current node which is reflected in the end-to-end QoS. That is, the bandwidth value is equal, and a value obtained by subtracting the delay time of link QoS can be set as the delay time of end-to-end QoS and sent. After completion of a connection setup, the connection management unit 310 can store connection information (S650). The connection information may include connection information requested from the preceding node and connection information that the current node has requested the next node to send. Table 1 is an example of connection information displayed in a list.

TABLE 1

| Name | Description |
|---|---|
| Source Node | Source node of end-to-end connection |
| Destination Node | Destination node of end-to-end connection |
| Connection ID | ID for discriminating connection |
| Next Hop | Next node |
| Link QoS | QoS required for a link between the current node and |
| | the next node (bandwidth, delay time) |

where, if a connection managed by a node is not used for a given period of time, the connection management unit 310 of the node can delete the connection information stored for the connection and release the resources allocated for the connection.

In contrast, if the allocated resources do not satisfy a predetermined level of QoS, the connection setup is considered as a failure (S660).

Meanwhile, the connection management unit 310 of each node can receive, from the link quality measuring unit 320, the QoS of a link in which the node is included. If the received QoS does not satisfy a predetermined level, i.e., connection QoS, this can be considered as a failure in QoS provision.

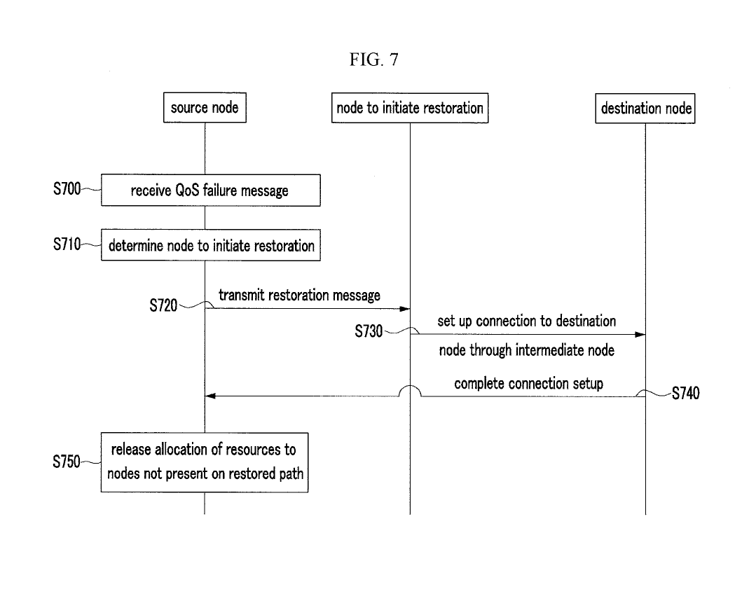

FIG. 7 is a flowchart showing a method for the connection management unit 310 of the routing apparatus 300 to restore a connection that has failed in QoS provision according to an exemplary embodiment of the present invention.

Referring to FIG. 7, a node involved in a connection has failed in QoS provision, the connection management unit 310 of the routing apparatus 300 which manages the connection transmits a QoS failure message to the source node S, and the connection management unit 310 of the source node S receives the QoS failure message (S700).

Having received the QoS failure message, the connection management unit 310 of the source node S determines a node to initiate the restoration (S710), and transmits a restoration request message to the node that is to initiate the restoration (S720).

The connection management unit 310 of the node to initiate the restoration sets up a connection to a destination node via an intermediate node (S730). For instance, the connection management unit 310 of the node to initiate the restoration sets up a connection with the next node, e.g., an intermediate node N1, and checks whether the connected node is the destination node D. If the connected node is not the destination node D, the connection management unit 310 transmits a connection setup request to the next node, e.g., an intermediate node N2, and repeats the above process until a connection with the destination node D is established.

When the connection with the destination node is established, the destination node D is able to notify the source node S of completion of the connection setup (S740).

Afterwards, the connection management unit 310 of the source node releases the allocation of resources to nodes not present on the restored path, among the nodes present on the existing path (S750).

In a wireless network that performs multi-hop communication, a required QoS level can be maintained by setting up a connection at each intermediate node and, at the same time, allocating resources.

Moreover, a path satisfying a required QoS level can be easily configured by including QoS information of each link in routing information.

In addition, overall quality requirements are fulfilled by dividing required end-to-end QoS into QoS for each link.

Furthermore, if the QoS required by an intermediate node is not satisfied, this can be restored quickly.

The exemplary embodiments of the present invention described above are not only implemented by the method and apparatus, but it may be implemented by a program for executing the functions corresponding to the configuration of the exemplary embodiment of the present invention or a recording medium having the program recorded thereon.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for a first node to set up a connection in a wireless network, the method comprising:
receiving a connection setup request directed to a destination node;
determining a predicted path leading to the destination node and a second node that follows;
allocating resources between the first node and the second node so as to satisfy required link QoS (Quality of Service);
transmitting a connection setup request to the second node through the allocated resources; and
receiving a connection setup complete message from the destination node.

2. The method of claim 1, wherein the predicted path is a path having the smallest number of hops, among at least one path satisfying an end-to-end QoS level required between the first node and the destination node.

3. The method of claim 1, wherein the second node is a node which is present on the predicted path and adjacent from the first node.

4. The method of claim 1, wherein the allocating of resources comprises:
deriving the link QoS based on an end-to-end QoS level required between the first node and the destination node and the number of hops on the predicted path; and
allocating time slot resources so as to satisfy the link QoS.

5. The method of claim 4, wherein the deriving of the link QoS comprises:
setting the bandwidth of the link QoS to be equal to the bandwidth of the end-to-end QoS; and
setting the delay time of the link QoS to be a value obtained by dividing the delay time of the end-to-end QoS by the number of hops.

6. The method of claim 5, wherein the allocating of time slot resources comprises:
determining the number of allocated time slots based on the bandwidth of the link QoS; and
determining the position of allocated time slots based on the delay time of the link QoS.

7. The method of claim 5, wherein the transmitting of the connection setup request comprises further transmitting information representative of the link QoS which is reflected in the end-to-end QoS.

8. The method of claim 1, further comprising storing source node information, destination node information, second node information, and link QoS information.

9. A method for a first node to restore a connection to support QoS in a wireless network, the method comprising:
receiving a QoS failure message indicative of a failure in QoS provision from a second node present on a routing path;
determining a third node to initiate the restoration of a connection;
transmitting a restoration request message to the third node; and
receiving a connection setup complete message from a destination node.

10. The method of claim 9, further comprising releasing resources allocated to a fourth node not present on a restored path among the nodes present on the routing path.

11. The method of claim 10, wherein the releasing of resources comprises:
transmitting a resource release request to the fourth node; and
receiving a resource release response from the fourth node.

12. A method for a first node to set up a routing path to support QoS in a wireless network, the method comprising:
exchanging routing information with a second node being a neighboring node;
forming a network topology based on the routing information received from the second node;
receiving a connection setup request directed to the destination node; and
determining a predicted path toward the destination node and a third node that follows based on the network topology.

13. The method of claim 12, wherein, in the exchanging of routing information, a Link State Routing (LSR) technique or an Optimized Link State Routing (OLSR) is used.

14. The method of claim 12, wherein the routing information includes QoS information that can be provided by a link connecting the first node and the second node.

15. The method of claim 12, further comprising:
allocating resources so as to satisfy link QoS (Quality of Service) required between the first node and the third node; and
transmitting a connection setup request to the third node through the allocated resources.

16. An apparatus for routing at a first node to support QoS in a wireless network, the apparatus comprising:
a connection management unit that receives a connection setup request directed to a destination node, determines a predicted path toward the destination node and a second node that follows, and transmits a connection setup request to the second node; and
a resource allocation unit that allocates resources so as to satisfy link QoS required between the first node and the second node.

17. The apparatus of claim 16, wherein the connection management unit selects, as the predicted path, a path having the smallest number of hops among at least one path satisfying an end-to-end QoS level required between the first node and the destination node.

18. The apparatus of claim 16, wherein the connection management unit derives the link QoS based on the number of end-to-end QoS level required between the first node and the destination node and the number of hops on the predicted path,
the resource allocation unit allocates time slot resources so as to satisfy the link QoS.

19. The apparatus of claim 16, further comprising:
a routing unit that exchanges routing information with a third node being a neighboring node; and
a routing information management unit that forms a network topology based on the routing information.

20. The apparatus of claim 16, further comprising a link quality measuring unit that measures the quality of a link managed by the first node.
